(19) United States
(12) Patent Application Publication
(10) Pub. No.: US 2005/0123223 A1
(43) Pub. Date: Jun. 9, 2005

(54) Linear guide way with assembling end-cup and the method of fabricating

(76) Inventor: Chi-Meng Liao, Taichung (TW)

Correspondence Address: CHARLES E. BAXLEY, ESQ., 90 JOHN STREET, THIRD FLOOR, NEW YORK, NY, 10038, US

(21) Appl. No.: 10/728,590

(22) Filed: Dec. 4, 2003

(51) Int. Cl. F16C 29/06

(52) U.S. Cl. 384/45

(57) ABSTRACT

The present invention relates to a linear guide way with assembling end-cup and the method of fabricating, the structure of end-cup includes the base-part and the out-cover. The characteristic of the linear guide way with assembling end-cup and the method of fabricating was that is easy to install the roller, thereby can reduce the time of assembling and raise the efficiency of assembling.

### BACKGROUND OF THE INVENTION

1. Field of the Invention

The present invention relates to a linear guide way with assembling end-cup and the method of fabricating, and more particularly to end-cup structure for linear guide way.

2. Description of the Prior Arts

Referring to FIG. 7, which shows a conventional linear guide way, wherein the linear guide way generally includes a rail (not shown), slide block 20 and two out-covers 60. Each of the out-covers 60 includes a base-part 61 and a guide plate 62, which enables the rollers (not shown) to roll in circles.

In assembly, the rollers need to be filled along inner side surface of a “ [symbol] ”-shaped slide block 20, this assembling method is very time-consuming. It will be more difficult to install the rollers in smaller linear guide way.

The present invention has arisen to mitigate and/or obviate the afore-described disadvantages of the conventional linear guide way and method for assembling the same.

### SUMMARY OF THE INVENTION

The primary object of the present invention is to provide a linear guide way with assembling end-cup which can be easily and quickly assembled, and thus the cost of the linear guide way is relatively lowered.

The secondary object of the present invention is to provide a method for assembling linear guide way with assembling end-cup, this method is designed to improve the assembly efficiency and shorten the time of assembling.

In accordance with one aspect of the present invention, there is provided with a linear guide way with assembling end-cup, which at least includes: a rail, a slide block, a plurality of rollers and end-cups, wherein the rail is limited in length and on both sides surfaces of which is respectively provided with a sliding groove parallel to the rail; the slide block is slidably mounted onto the guide way and which interiorly provided with sliding groove for cooperating with the sliding groove of the rail; the plurality of rollers received and roll in the sliding groove between the rail and the slide block, so as to reduce the sliding friction between the slide block and the rail; the end-cup is fixed to both ends of the slide block and interiorly provided with circulation passage for enabling the rollers to roll in circles.

A method for assembling the rollers is initially by fixing a first base-part and a first out-cover to an end of a slide block, and then fixing a second base-part to an opposite end of the slide block, and followed by filling the rollers into the slide block via the guiding holes on the outer surface of the second base-part, after the rollers have been filled in the slide block and then fixing a second out-cover to the second base-part so as to form a complete circulation path, and thus the assembly is finished.

The present invention will become more obvious from the following description when taken in connection with the accompanying drawings, which shows, for purpose of illustrations only, the preferred embodiment in accordance with the present invention.

### BRIEF DESCRIPTION OF THE DRAWINGS

FIG. 1 is an exploded view of showing a linear guide way with assembling end cap in accordance with the present invention;

FIG. 2 is an inside plan view of the base-part of the end-cup in FIG. 1;

FIG. 3 is an outside plan view of the base-part of the end-cup in FIG. 1;

FIG. 4 is an inside plan view of the out-cover in FIG. 1; FIG. 5 is an outside plan view of the out-cover in FIG. 1;

FIG. 5 is an outside plan view of the out-cover in FIG. 1;

FIG. 6 is an operational view of illustrating the method for assembling the roller in the linear guide way;

FIG. 7 shows a conventional linear guide way.

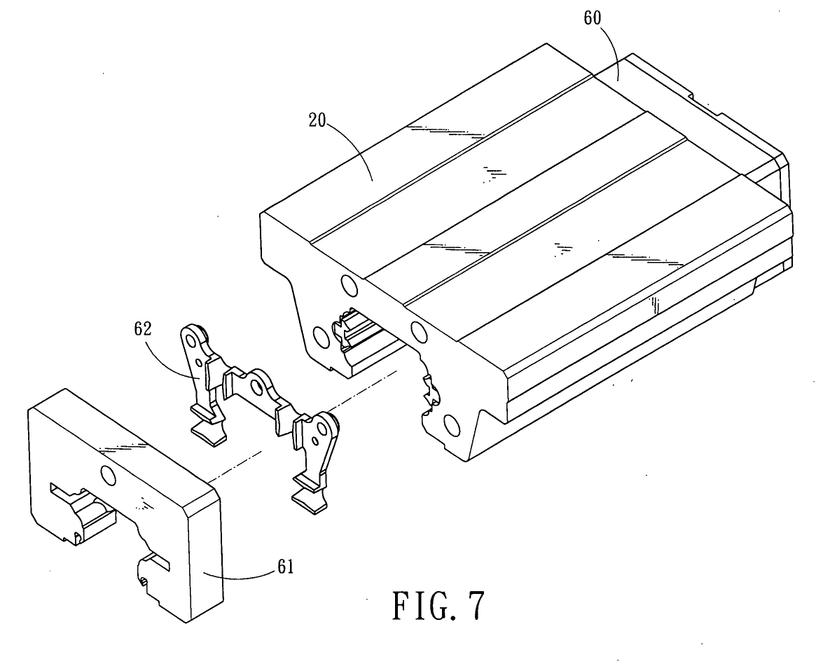

### DETAILED DESCRIPTION OF THE PREFERRED EMBODIMENTS

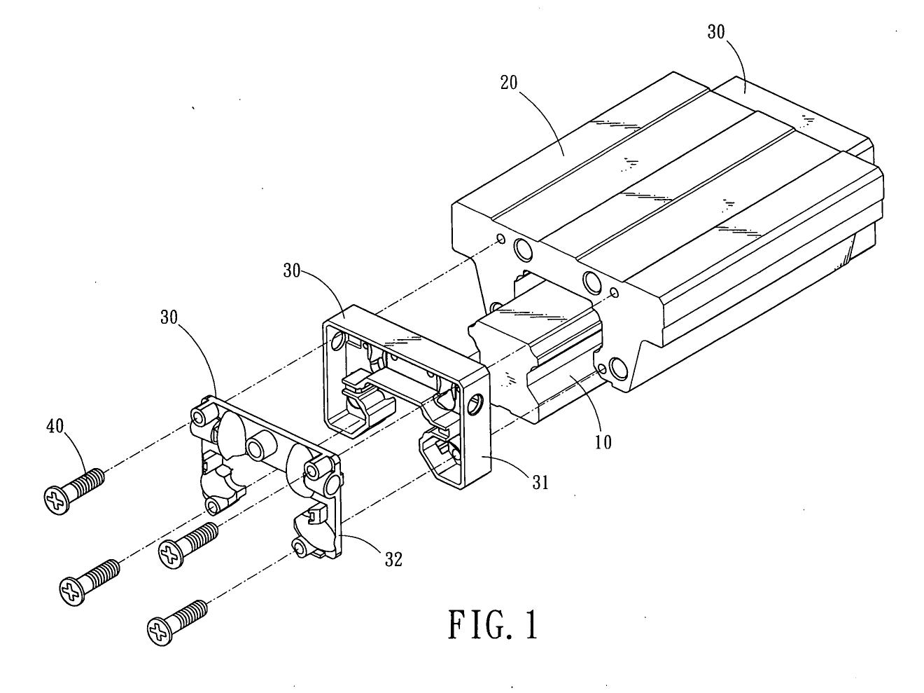

Referring to FIG. 1, which is an exploded view of showing a linear guide way with assembling end-cup in accordance with the present invention. Wherein the linear guide way generally includes a slide block 20 mounted onto a rail 10, at both sides of the slide block 20 is respectively provided with an end-cup 30, each of the end-cups 30 is interiorly defined with circulation passages for enabling rollers (not shown) to roll in circles. Base-part 31 and out-cover 32 of each of the end-cups 30 are fixed to the slide block 20 by virtue of screws 40.

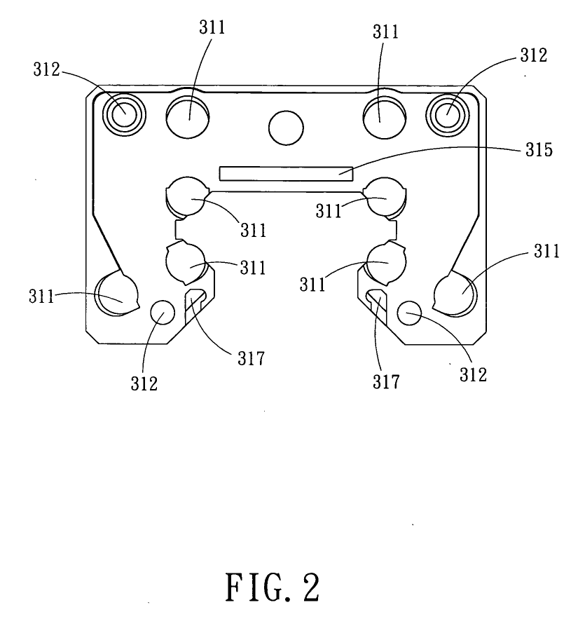

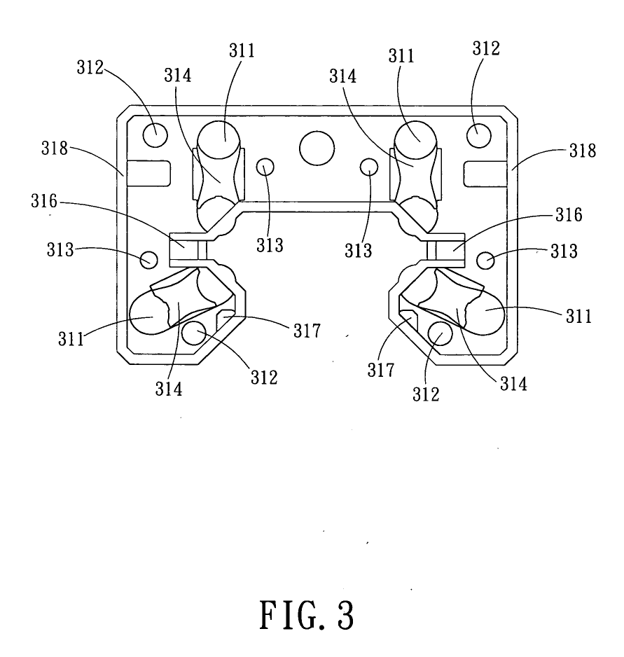

FIG. 2 is an inside plan view of the base-part of the end-cup in FIG. 1; FIG. 3 is an outside plan view of the base-part of the end-cup in FIG. 1. Wherein the base-part 31 is used to cooperate with the slide block 20 in FIG. 1, the base-part 31 is provided with more than one set of guiding holes 311, through the guiding holes 311 the rollers (not shown) are allowed to slide in and out of the slide block 20, the base-part 31 is further defined with screw holes 312 for allowing passage of screws. The outer surface of the base-part 31 serves to abut against the out-cover 32 shown in FIG. 1, locating holes 313 are defined on the outer surface of the base-part 31 for enabling the base-part 31 to accurately fixed to the out-cover 32. Still on the outer surface of the base-part 31 between the guiding holes 311 of each set is formed with a curved surface 314. Furthermore, an upper locating slot 315, a side locating slot 316 and a lower locating slot 317 are respectively defined on the base-part 31, so as to enable the base-part 31 to position roller retainers (not shown). The base-part 31 is further provided about the periphery with walls 318 with predetermined height for preventing disengagement of the rollers out of the guiding holes 311 in assembly.

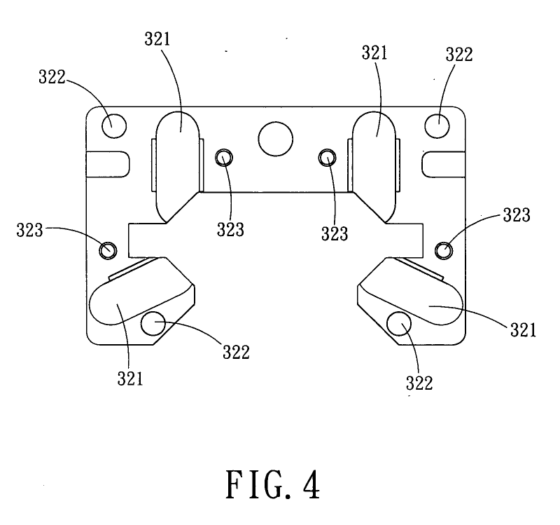

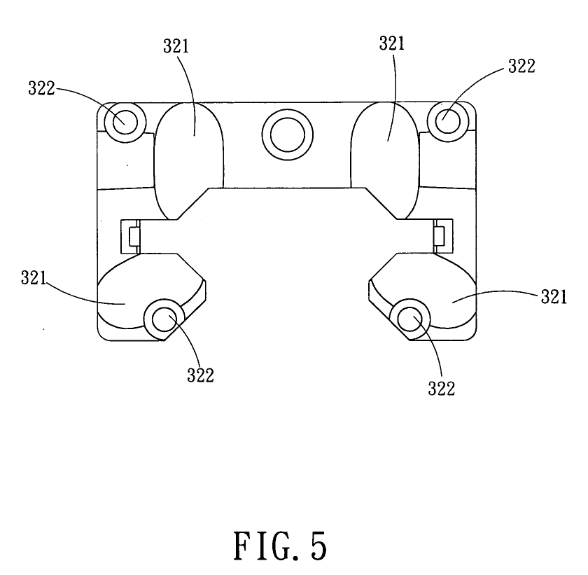

FIG. 4 is an inside plan view of the out-cover in FIG. 1; FIG. 5 is an outside plan view of the out-cover in FIG. 1. Wherein the out-cover 32 is provided with circulation passages 321 in corresponding to the respective sets of guiding holes 311 of the base-part 31, so as to form a complete circulation path for allowing the rollers to roll in circles. The out-cover 32 is further provided with screw holes 322 in corresponding to the screw holes 312 of the base-part 31 for passage of screws. On the inner surface of the out-cover 32 is defined with locking pins 323 in corresponding to the locating holes 313 on the outer surface of the base-part 31, so as to ensure that the base-part 31 can be accurately positioned. In addition, the material of the out-cover 32 can be elastoplastics, so as to improve the effect for absorbing the collision noise.

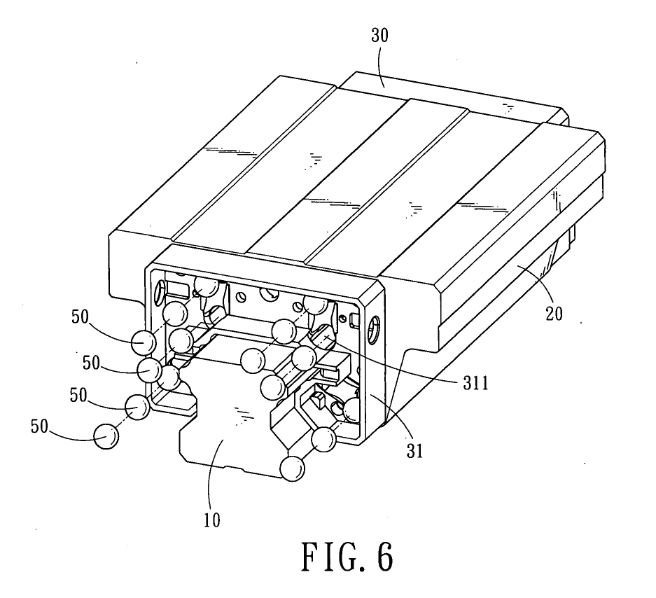

FIG. 6 is an operational view of illustrating the method for assembling the roller in the linear guide way. Wherein the method for assembling the rollers 50 is initially by fixing an end-cup 30 to an end of the slide block 20, and then fixing the base-part 31 to an opposite end of the slide block 20, followed by filling the rollers 50 into the slide block 20 via the guiding holes 311 on the outer surface of the base-part 31. After the rollers 50 have been filled in the slide block 20 and then fixing the out-cover 32 to the base-part 31 so as to form a complete circulation path. This assembly method can improve the efficiency for assembling the linear guide way. On the other hand, an automatic machine can be fit in the guiding holes 311 for filling the rollers 50 in the slide block 20 automatically, by this way, the assembly time can be substantially reduced.

While we have shown and described various embodiments in accordance with the present invention, it should be clear to those skilled in the art that further embodiments may be made without departing from the scope of the present invention.

1. A linear guide way with assembling end-cup comprising:
a rail, on both sides surfaces of which is respectively provided with a sliding groove parallel to the rail;
a slide block slidably mounted onto the guide way, the slide block interiorly provided with sliding groove used to cooperate with the sliding groove of the rail;
a plurality of rollers received and rolling in the sliding groove between the rail and the slide block, so as to reduce the sliding friction between the slide block and the rail;
an end-cup fixed to both ends of the slide block and interiorly provided with circulation passage for enabling the rollers to roll in circles;
the end-cup including base-part and out-cover, the base-part having at least two sets of guiding holes, through the guiding holes the rollers can be filled in the slide block easily and quickly, the out-cover being provided on an outer surface of the base-part, the out-cover defined with at least two circulation passages used to cooperate with the guiding holes, so as to form a complete circulation path.

2. The linear guide way with assembling end-cup as claimed in claim 1, wherein the slide block is interiorly provided with roller retainers for preventing disengagement of the rollers, the base-part is able to position the roller retainers.

3. The linear guide way with assembling end-cup as claimed in claim 1, wherein a side of the out-cover abutting against the base-part is provided with locking pins, whereas on the corresponding position of the base-part is defined with locating holes, such that the out-cover can be accurately fixed to the base-part.

4. The linear guide way with assembling end-cup as claimed in claim 1, wherein between the guiding holes of each set is formed with a curved surface configured to cooperate with the circulation passage, so as to enable the rollers to smoothly roll through the circulation passage.

5. The linear guide way with assembling end-cup as claimed in claim 1, wherein the out-cover is made of elastoplastics.

6. A method for assembling rollers to linear guide way, wherein a linear guide way is the linear guide way as claimed in claim 1 which respectively provided at both ends with an end-cup, the method for assembling the rollers is initially by fixing a first base-part and a first out-cover to an end of a slide block, and then fixing a second base-part to an opposite end of the slide block, and followed by filling the rollers into the slide block via the guiding holes on the outer surface of the second base-part, after the rollers have been filled in the slide block and then fixing a second out-cover to the second base-part so as to form a complete circulation path, and thus the assembly is finished.

7. A method for assembling rollers to linear guide way as claimed in claim 6, wherein an automatic machine can be fit in the guiding holes for filling the rollers in the slide block automatically, by this way, the assembly time can be substantially reduced.
